(19) United States
(12) Patent Application Publication
(10) Pub. No.: US 2018/0055162 A1
(43) Pub. Date: Mar. 1, 2018

(54) Lighted Cane System

(71) Applicant: Eileen Blackdeer, Black River Falls, WI (US)

(72) Inventor: Eileen Blackdeer, Black River Falls, WI (US)

(21) Appl. No.: 15/252,841

(22) Filed: Aug. 31, 2016

(51) Int. Cl. A45B 3/04; F21V 23/04; F21V 33/00; F21V 23/02; F21L 4/00

(52) U.S. Cl. CPC A45B 3/04; F21V 23/0414; A45B 2009/005; F21V 23/02; F21L 4/00; F21V 33/0064

(57) ABSTRACT

A lighted cane system for a cane may be gripped thereby facilitating the cane to assist with walking. A light emitter is coupled to the cane. The light emitter emits light outwardly from the cane thereby facilitating walking in the dark. A switch is coupled to the cane. The switch is manipulated to turn the light emitter on and off.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cane devices and more particularly pertains to a new cane device for illuminating light to assist with walking in the dark.

### BRIEF SUMMARY OF THE INVENTION

An embodiment of the disclosure meets the needs presented above by generally comprising a cane may be gripped thereby facilitating the cane to assist with walking. A light emitter is coupled to the cane. The light emitter emits light outwardly from the cane thereby facilitating walking in the dark. A switch is coupled to the cane. The switch is manipulated to turn the light emitter on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a lighted cane system according to an embodiment of the disclosure.

FIG. 2 is a front phantom view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 2 of an embodiment of the disclosure.

### DETAILED DESCRIPTION OF THE INVENTION

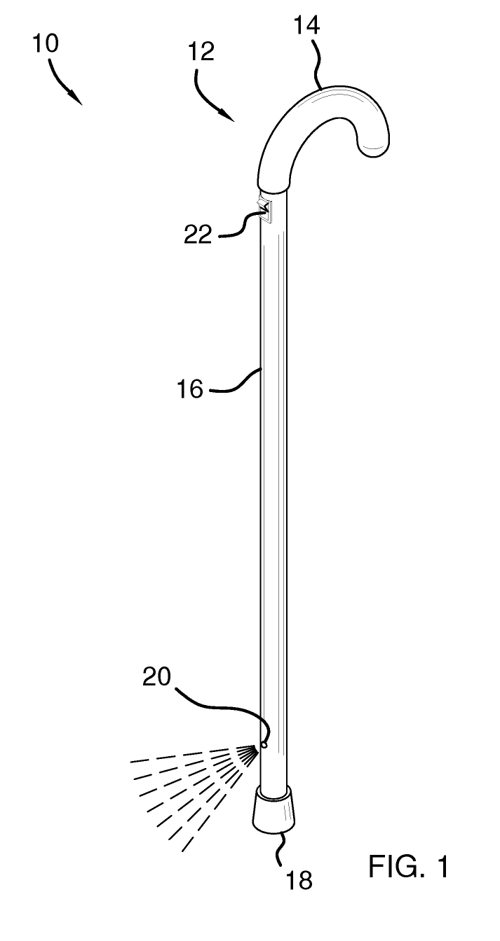

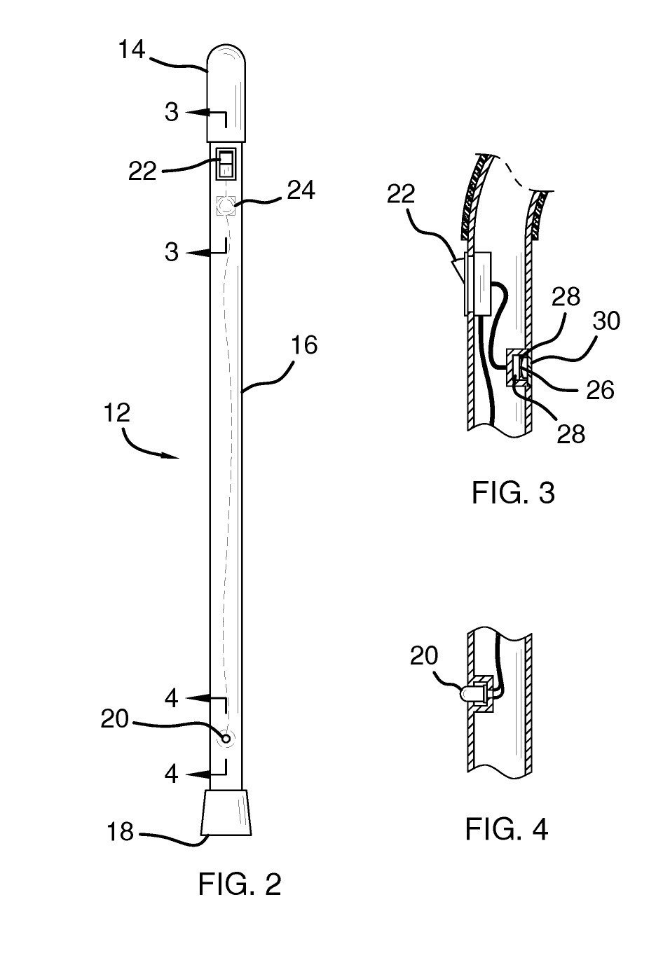

With reference now to the drawings, and in particular to FIGS. 1 through 4 thereof, a new cane device embodying the principles and concepts of an embodiment of the disclosure and generally designated by the reference numeral 10 will be described.

As best illustrated in FIGS. 1 through 4, the lighted cane system 10 generally comprises a cane 12. The cane 12 may be gripped to assist with walking. The cane 12 has a handle 14 and a shaft 16. The shaft 16 has a distal end 18 with respect to the handle 14. The cane 12 may comprise a walking cane of any conventional design.

A light emitter 20 is provided. The light emitter 20 is coupled to the cane 12 to emit light outwardly from the cane 12. Thus, the light emitter 20 assists with walking in the dark. The light emitter 20 is positioned on the shaft 16. The light emitter 20 is positioned closer to the distal end 18 than the handle 14. The light emitter 20 may comprise an LED or the like.

A switch 22 is provided. The switch 22 is coupled to the cane 12 and the switch 22 may be manipulated. The switch 22 is electrically coupled to the light emitter 20. Thus, the switch 22 turns the light emitter 20 on and off. The switch 22 is positioned on the shaft 16 and the switch 22 is positioned closer to the handle 14 than the distal end 18.

A power supply 24 is provided and the power supply 24 is positioned in the cane 12. The power supply 24 is electrically coupled to the switch 22. The power supply 24 comprises at least one battery 26. A well 28 extends inwardly on the cane 12. The well 28 is positioned on the shaft 16 and the at least one battery 26 is positioned in the well 28. A cover 30 is removably coupled to the shaft 16 and the cover 30 covers the well 28.

In use, the cane 12 is manipulated to assist with walking. The switch 22 is manipulated to turn the light emitter 20. Thus, the light emitter 20 provides light to walk in the dark. The cover 30 is removed from the well 28 and the at least one battery 26 is replaced when the at least one battery 26 is dead.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A lighted cane system comprising:
a cane being configured to be gripped thereby facilitating said cane to assist with walking, said cane having a handle and a shaft, said shaft having a distal end with respect to said handle, said handle being arcuate and extending from a top of said shaft in a first direction, said shaft having a forward edge facing in a second direction diametrically opposed to said first direction;
a light emitter being coupled to said cane wherein said light emitter is configured to emit light outwardly from said cane thereby facilitating walking in the dark, said light emitter having a bulb, said bulb having a cylindrical section positioned in alignment with and extending through said forward edge of said shaft, said bulb having a dome section extending from said cylindrical section, said dome section being positioned extending outwardly from said forward edge of said shaft; and
a switch being coupled to said cane wherein said switch is configured to be manipulated, said switch turning said light emitter on and off.

2. The system according to claim 1, wherein
said light emitter is positioned closer to said distal end than said handle.

3. The system according to claim 1, wherein
said switch is electrically coupled to said light emitter such that said switch turns said light emitter on and off, said switch being positioned on said shaft, said switch being positioned closer to said handle than said distal end.

4. The system according to claim 3, further comprising a power supply being positioned in said cane, said power supply being electrically coupled to said switch, said power supply comprising at least one battery.

5. A lighted cane system comprising:
a cane being configured to be gripped thereby facilitating said cane to assist with walking, said cane having a handle and a shaft, said shaft having a distal end with respect to said handle, said handle being arcuate and extending from a top of said shaft in a first direction, said shaft having a forward edge facing in a second direction diametrically opposed to said first direction;
a light emitter being coupled to said cane wherein said light emitter is configured to emit light outwardly from said cane thereby facilitating walking in the dark, said light emitter being positioned on said shaft, said light emitter being positioned closer to said distal end than said handle, said light emitter having a bulb, said bulb having a cylindrical section positioned in alignment with and extending through said forward edge of said shaft, said bulb having a dome section extending from said cylindrical section, said dome section being positioned extending outwardly from said forward edge of said shaft;
a switch being coupled to said cane wherein said switch is configured to be manipulated, said switch being electrically coupled to said light emitter such that said switch turns said light emitter on and off, said switch being positioned on said shaft, said switch being positioned closer to said handle than said distal end; and
a power supply being positioned in said cane, said power supply being electrically coupled to said switch, said power supply comprising at least one battery.
